(19) United States
(12) Patent Application Publication
(10) Pub. No.: US 2020/0391766 A1
(43) Pub. Date: Dec. 17, 2020

(54) MULTI-MODE COMMUNICATION METHOD FOR AUTONOMOUS TRANSPORT SYSTEM OF MINING VEHICLE AND APPARATUS THEREOF

(71) Applicant: Beihang University, Beijing (CN)

(72) Inventors: Yunpeng WANG, Beijing (CN); Daxin TIAN, Beijing (CN); Xuting DUAN, Beijing (CN); Yuanhao ZHAO, Beijing (CN); Guizhen YU, Beijing (CN); Haiyang YU, Beijing (CN); Yilong REN, Beijing (CN)

(21) Appl. No.: 16/895,473

(22) Filed: Jun. 8, 2020

(30) Foreign Application Priority Data
Jun. 11, 2019 (CN) 201910502042.8

(51) Int. Cl. B60W 60/00; G05D 1/00; H04W 72/08

(52) U.S. Cl. CPC B60W 60/0025; G05D 2201/021; H04W 72/08; G05D 1/0022

(57) ABSTRACT

The present invention provides a multi-mode communication method for an autonomous transport system of a mining vehicle and an apparatus thereof. The method includes: acquiring performance parameters of each channel, where the performance parameters comprise bandwidth, delay, jitter and packet loss rate; calculating a performance function for each channel according to the acquired performance parameters of each channel; standardizing the performance function of each channel; constructing a judgment matrix for characterizing a relative importance of a performance parameter of each channel; performing a consistency check on the constructed judgment matrix; calculating a weight index matrix according to parameters of the constructed judgment matrix, and performing a normalization process; calculating a weighted evaluation indicator; determining whether to switch communication network according to the calculated weighted evaluation indicator.

### TECHNICAL FIELD

The present disclosure relates to the technical fields of robot wireless communication and autonomous driving, and in particular to a multi-mode communication method for an autonomous transport system of a mining vehicle and an apparatus thereof.

### BACKGROUND

Autonomous vehicles used in mines are a research hot topic in recent years. Autonomous vehicles can help solve the collection problems of some mines and the harmful radiation problems of some mines. Autonomous driving is realized with mainly driving robots and embedded wire control means; and through perception and analysis of the environment near the vehicle, an optimal underlying control mode can be obtained based on V2X communication and cloud computing. However, due to the complex geographical conditions of the mines, locations where low-latency, high-reliability communication facilities can be established are either few or costly, therefore it is desired to provide a low-cost, high-efficiency communication method to ensure the operation of autonomous vehicles used in mines.

### SUMMARY OF PARTICULAR EMBODIMENTS

Embodiments of the present disclosure provide a multi-mode communication method for an autonomous transport system of a mining vehicle and an apparatus thereof, which can solve the communication problem in autonomous mining vehicles, and improve the efficiency and reliability of mining vehicle communication.

In order to achieve the above object, the embodiments of the present disclosure include the following technical solutions.

In a first aspect, an embodiment of the present disclosure provides a multi-mode communication method for an autonomous transport system of a mining vehicle, comprising:

acquiring performance parameters of each channel, where the performance parameters comprise bandwidth, delay, jitter and packet loss rate;

calculating a performance function for each channel according to the acquired performance parameters of each channel;

standardizing the performance function of each channel;

constructing a judgment matrix for characterizing a relative importance of a performance parameter of each channel;

performing a consistency check on the constructed judgment matrix;

calculating a weight index matrix according to parameters of the constructed judgment matrix, and performing a normalization process;

calculating a weighted evaluation indicator;

determining whether to switch communication network according to the calculated weighted evaluation indicator.

In the method above, the calculating a performance function for each channel according to the acquired performance parameters of each channel comprises:

collecting data every 1 s, and determining size of the data, n, according to a preset sampling period T with a calculation formula:

$$n = \frac{1}{T} ;$$

calculating X_{i,k} (k=B,D,J,L) according to a calculation formula:

$${X}_{i , k} ( k = B , D , J , L ) = \frac{1}{n} {\sum }_{j = 1}^{n} {x}_{i , {k}_{j}} ( k = B , D , J , L ) ;$$

where X_{i,k} (k=B,D,J,L) is the average of a series of data of size n, i is a channel identifier, B is bandwidth, D is delay, J is jitter and L is packet loss rate.

In the method above, the standardizing the performance function of each channel comprises:

standardizing the performance function X_{i,k} (k=B,D,J,L) of each channel into Y_{i,k} (k=B,D,J,L), and

Y_{i,k}(k=B=(k=B)/X_{0,k}(k=B)

Y_{i,k}(k=D,J,L)=1−X_{i,k},(k=D,J,L)/X_{0,k}(k=D,J,L)

where X_{0,k} (k=B,D,J,L) is a standard performance function, determined by technical indicators of a corresponding application, and in solving an autonomous mining vehicle problem, the standard performance function has the set of values below:

X_{0,k}(k=B,D,J,L)=(50 Mbps,150 ms,10 ms,10%).

In the method above, the constructing the judgment matrix comprises:

generating an element table for the judgment matrix A as shown in Table 1 according to a nine-point scale:

TABLE 1
Element table for judgment matrix A

| Importance of parameter u | |
|---|---|
| relative to parameter v | aᵤᵥ |
| Equal importance | 1 |
| Moderate importance | 3 |
| Story importance | 5 |
| Very strong importance | 7 |
| Extreme importance | 9 |

where the judgment matrix A is a 4×4 matrix, and aᵤᵥ in the matrix denotes the importance of a parameter u relative to a parameter v.

In the method above, the performing a consistency check on the constructed judgment matrix comprises: performing a consistency check on the constructed judgment matrix, and if a consistency check parameter CR<0.1, determining the consistency check is passed.

In the method above, the calculating a weight index matrix according to parameters of the constructed judgment matrix and performing a normalization process comprises:

first, performing initial calculation of the element values of the weight index matrix W according to the calculation formula:

$${W}_{i , k} = \sqrt[4]{{Π}_{j} {a}_{k j}} ( k , j = B , D , J , L ) ;$$

then, performing a normalization process according to the processing formula:

$${w}_{i , k} = \frac{{w}_{i , k}}{Σ {w}_{i , k}} ( k = B , D , J , L ) ,$$

after the normalization process, the final weight index matrix W is obtained.

In the method above, the calculating a weighted evaluation indicator comprises: calculating a weighted evaluation indicator according to the standardized performance function of each channel and the final weight index matrix obtained after normalization, according to the calculation formula:

Mᵢ=Σw_{i,k}Y_{i,k}(k=B,D,J,L),

where Mᵢ is the weighted evaluation indicator.

In the method above, the determining whether to switch communication network according to the calculated weighted evaluation indicator comprises:

of all communication modes, determining a communication mode with the largest M as the best communication network; and if it is more than 10% larger than the indicator of the current network, switching.

In the method above, the method further comprises selecting other candidate network according to the magnitude of M value.

In a second aspect, an embodiment of the present disclosure provides a multi-mode communication apparatus for an autonomous transport system of a mining vehicle, comprising:

an acquisition module, configured to acquire performance parameters of each channel, where the performance parameters comprise bandwidth, delay, jitter and packet loss rate;

a calculation module, configured to calculate a performance function for each channel according to the acquired performance parameters of each channel;

a standardization module, configured to standardize the performance function of each channel;

a construction module, configured to construct a judgment matrix for characterizing a relative importance of a performance parameter of each channel;

a checking module, configured to perform a consistency check on the constructed judgment matrix;

a normalization module, configured to calculate a weight index matrix according to parameters of the constructed judgment matrix, and perform a normalization process;

the calculation module is further configured to calculate a weighted evaluation indicator;

a switching module, configured to determine whether to switch communication network according to the calculated weighted evaluation indicator.

Compared with the prior art, the technical solutions provided by the present disclosure have the following beneficial effects.

1. Network characteristics can be well distinguished according to the difference in performance between various types of networks in different locations. Through a standardization analysis of network characteristics (bandwidth, delay, jitter, packet loss rate), a standardized performance function can be obtained. Based on the standardized performance function, a normalized and weighted performance indicator can be constructed when a consistency check is passed. The indicator is then the criterion for judging whether or not to switch network under multi-mode communication.

2. Compared with conventional communication methods for autonomous mining vehicles, the technical solutions provided by the present disclosure are advantageous in that the present disclosure does not require high energy consumption signal radiation devices and signal enhancement devices in its implementation, and only requires a performance evaluation of existing multi-mode communication equipment to determine which communication mode to use; the technical solutions provided by the present disclosure are easy to implement and inexpensive. In addition, the reliability of data is ensured due to the high development of the sensor technology, which further ensures the reliability of the multi-mode communication method for an autonomous transport system of a mining vehicle that uses network performance data as an indicator.

### BRIEF DESCRIPTION OF THE DRAWINGS

In order to more clearly illustrate the technical solutions in the embodiments of the present disclosure, the drawings used in the description of the embodiments will be briefly described below. It would be apparent to those skilled in the art that the drawings described herein are only some embodiments of the present invention, and other drawings can be obtained without inventive effort in light of these drawings.

FIG. 1 is a flow chart of a multi-mode communication method for an autonomous transport system of a mining vehicle provided by the present disclosure;

FIG. 2 is a schematic diagram of an application embodiment of a multi-mode communication method for an autonomous transport system of a mining vehicle provided by the present disclosure.

### DETAILED DESCRIPTION OF PARTICULAR EMBODIMENTS

The technical solutions in the embodiments of the present disclosure will be described clearly and completely below with reference to the accompanying drawings. It would be apparent to those skilled in the art that the embodiments described herein are only some embodiments of the present invention, instead of all embodiments. Any other embodiment obtained by those skilled in the art based on the embodiments of the present disclosure without inventive effort shall fall within the scope of the present invention.

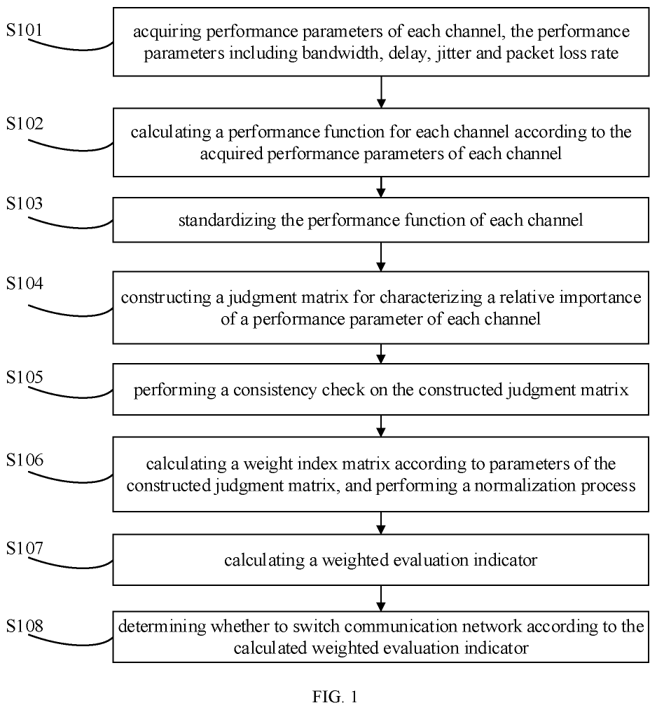

At present, most autonomous mining vehicles travel on a predetermined route, and normally cannot deal with emergencies or real-time driving mode changing. There are two main reasons for this situation: First, traffic conditions in mines are complex, which results in relatively low reliable intelligent algorithms and relatively incomplete intelligent libraries; second, geographical conditions of mines are complex, and locations where low-latency, high-reliability communication facilities can be established are relatively few. Starting from the second point, the technical solutions provided by the present disclosure organically integrate multi-mode communication, realize an operation mode where 1+1>2, and improves the efficiency and reliability of mining vehicle communication. FIG. 1 is a flow chart of a multi-mode communication method for an autonomous transport system of a mining vehicle provided by the present disclosure. The method can be performed by a multi-mode communication apparatus for an autonomous transport system of a mining vehicle; the planning apparatus can be implemented with software, and configured in an autonomous mining vehicle. As shown in FIG. 1, according to an embodiment of the present disclosure the method includes the following.

S101. acquiring performance parameters of each channel, where the performance parameters comprise bandwidth, delay, jitter and packet loss rate.

S102. calculating a performance function for each channel according to the acquired performance parameters of each channel.

The calculating a performance function for each channel according to the acquired performance parameters of each channel in this step may specifically include:

collecting data every 1 s, and determining size of the data, n, according to a preset sampling period T with a calculation formula:

$$n = \frac{1}{T} ;$$

calculating X_{i,k} (k=B,D,J,L) according to a calculation formula:

$${X}_{i , k } ( k = B , D , J , L ) = \frac{1}{n} {\sum }_{j = 1}^{n} {x}_{i , {k}_{j}} ( k = B , D , J , L )$$

where X_{i,k} (k=B,D,J,L) is the average of a series of data of size n, i is a channel identifier, B is bandwidth, D is delay, J is jitter and L is packet loss rate.

S103. standardizing the performance function of each channel.

The standardizing the performance function of each channel in this step may specifically include:

standardizing the performance function X_{i,k} (k=B,D,J,L) of each channel into Y_{i,k} (k=B,D,J,L), and

Y_{i,k}(k=B)=X_{i,k},(k=B)/X_{0,k}(k=B)

Y_{i,k}(k=D,J,L)=1−X_{i,k},(k=D,J,L)/X_{0,k}(k=D,J,L)

where X_{0,k} (k=B,D,J,L) is a standard performance function, which is determined by technical indicators of the corresponding application. In solving an autonomous mining vehicle problem, the standard performance function may have the set of values below:

X_{0,k}(k=B,D,J,L)=(50 Mbps,150 ms,10 ms,10%).

S104. constructing a judgment matrix for characterizing a relative importance of a performance parameter of each channel.

A method for constructing the judgment matrix in this step may specifically include:

generating an element table for the judgment matrix A as shown in Table 1 according to Saaty's nine-point scale:

TABLE 1
Element table for judgment matrix A

| Importance of parameter u | |
|---|---|
| relative to parameter v | aᵤᵥ |
| Equal importance | 1 |
| Moderate importance | 3 |
| Story importance | 5 |
| Very strong importance | 7 |
| Extreme importance | 9 |

The judgment matrix A is a 4×4 matrix, and aᵤᵥ in the matrix denotes the importance of a parameter u relative to a parameter v.

S105. performing a consistency check on the constructed judgment matrix.

Specifically, performing a consistency check on the constructed judgment matrix, and if a consistency check parameter CR<0.1, determining the consistency check is passed.

S106. calculating a weight index matrix according to parameters of the constructed judgment matrix, and performing a normalization process.

Specifically, the calculating a weight index matrix according to parameters of the constructed judgment matrix and performing a normalization process may include:

First, performing initial calculation of the element values of the weight index matri.

W according to the calculation formula:

$${W}_{i , k} = \sqrt[4]{{Π}_{j} {a}_{k j}} ( k , j = B , D , J , L )$$

Then, performing a normalization process according to the processing formula:

$${w}_{i , k} = \frac{{w}_{i , k}}{Σ {w}_{i , k}} ( k = B , D , J , L )$$

After the normalization process, the final weight index matrix W is obtained.

S107. calculating a weighted evaluation indicator.

The calculating a weighted evaluation indicator in this step may specifically include: calculating a weighted evaluation indicator according to the standardized performance function of each channel and the final weight index matrix obtained after normalization; the calculation formula is:

Mᵢ=Σw_{i,k}Y_{i,k}(k=B,D,J,L)

where Mᵢ is the weighted evaluation indicator.

S108. determining whether to switch communication network according to the calculated weighted evaluation indicator.

The determining whether to switch communication network according to the calculated weighted evaluation indicator in this step may specifically include:

of all communication modes, determining a communication mode with the largest M as the best communication network; and if it is more than 10% larger than the indicator of the current network, switching, and selecting other candidate network according to the magnitude of M value.

Multi-mode communication has always been a research hot topic in the field of communication. In view of the poor reliability of information transmission and the instability of transmission performance in single-mode communication, the present disclosure provides a technical solution that applies multi-mode communication to autonomous mining vehicles. Nowadays various types of roadside and on-board sensors have high accuracy and reliability, therefore based on performance parameters of the communication modes, systematic judgment can be made on affecting weights of the parameters by using an analytic hierarchy process in operations research, and a state of the current network can be evaluated, which provides a decision basis for network selection and switching. The technical solution provided by the embodiment of the present disclosure does not require high energy consumption signal radiation devices and signal enhancement devices, and only requires a performance evaluation of the existing multi-mode communication equipment to determine whether to switch communication mode and which communication mode to switch into.

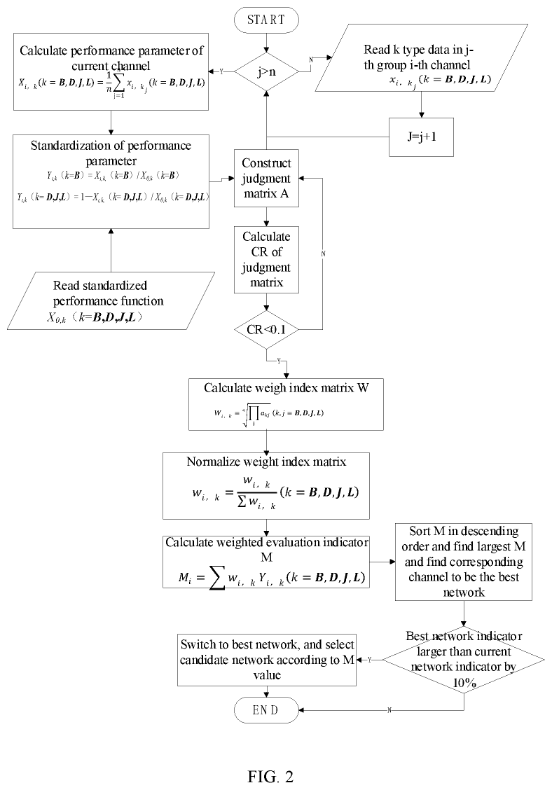

FIG. 2 is a schematic diagram of an application embodiment of a multi-mode communication method for an autonomous transport system of a mining vehicle provided by the present disclosure. As shown in FIG. 2, the method of this embodiment includes the following steps:

Step 1: obtaining a performance function X_{i,k} (k=B,D,J,L) of each channel, where B is bandwidth, D is delay, J is jitter and L is packet loss rate, and X_{i,k} (k=B,D,J,L) is the average of a series of data, where the data is collected every 1 s, and the size of the data, n, is determined according to a preset sampling period T:

$$n = \frac{1}{T} ;$$

$${X}_{i , k} ( k = B , D , J , L ) = \frac{1}{n} {\sum }_{i = 1}^{n} {x}_{i , {k}_{j}} ( k = B , D , J , L )$$

Step 2: standardizing the obtained performance function into Y_{i,k} (k=B,D,J,L). Because larger bandwidth and smaller delay, jitter and packet loss rate are desired, the following formula is used to standardize, so that the criterion is that the larger the evaluation indicator is, the better:

Yᵢ,k(k=B)=(k=B)/X_{0,k}(k=B)

Y_{i,k}(k=D,J,L)=(k=D,J,L)/X_{0,k}(k=D,J,L)

where X_{0,k} (k=B,D,J,L) is a standard performance function, which is determined by technical indicators of the corresponding application. In solving an autonomous mining vehicle problem, the standard performance function may have the set of values below:

X_{0,k}(k=B,D,J,L)=(50 Mbps,150 ms,10 ms,10%).

Step 3: constructing a judgment matrix A. This is a 4×4 matrix, where aᵤᵥ in the matrix denotes the importance of a parameter u relative to a parameter v. An element table for the judgment matrix A as shown in Table 1 can be generated according to Saaty's nine-point scale. Table 2 exemplifies an element table for the judgment matrix applicable to a mining vehicle.

TABLE 2
Element table for judgment matrix

| | | | |
|---|---|---|---|
| 1 | 3 | 5 | 7 |
| 1/3 | 1 | 3 | 5 |
| 1/5 | 1/3 | 1 | 3 |
| 1/7 | 1/5 | 1/3 | 1 |

Step 4: performing a consistency check on the judgment matrix A. The maximum eigenvalue of the matrix is 4.12, and the matrix order is 4, hence the consistency index:

$$CI = \frac{4.12 - 4}{4 - 1} = 0.04$$

For a matrix of order four, the random consistency index RI=0.90, then the consistency check parameter:

$$C R = \frac{CI}{RI} = 0.044 < 0.1$$

Therefore, the consistency check is passed.

Step 5: calculating a weight index matrix W:

$${W}_{i , k} = \sqrt[4]{{Π}_{i} {a}_{k j}} ( k , j = B , D , J , L ) ;$$

performing a normalization process:

$${w}_{i , k} = \frac{{w}_{i , k}}{Σ {w}_{i , k}} ( k = B , D , J , L )$$

to obtain W. Table 3 exemplifies a weight index matrix W table applicable to a mining vehicle.

TABLE 3
Weight index matrix W table

| | | | | |
|---|---|---|---|---|
| before | 3.20 | 1.50 | 0.67 | 0.31 |
| normalization | | | | |
| after | 0.56 | 0.26 | 0.12 | 0.06 |
| normalization | | | | |

Step 6: calculating a weighted evaluation indicator

Mᵢ=Σw_{i,k}Y_{i,k}(k=B,D,J,L).

Step 7: determining whether to switch communication network:

Of all communication modes, determining a communication mode with the largest M as the best communication network; and if it is more than 10% larger than the indicator of the current network, then switching. In addition, other candidate network can be selected according to the magnitude of M value.

The present disclosure also provides a multi-mode communication apparatus for an autonomous transport system of a mining vehicle, including an acquisition module, a calculation module, a standardization module, a construction module, a checking module, a normalization module and a switching module. Specifically, the acquisition module is configured to acquire performance parameters of each channel, where the performance parameters comprise bandwidth, delay, jitter and packet loss rate; the calculating module is configured to calculate a performance function for each channel according to the acquired performance parameters of each channel; the standardization module is configured to standardize the performance function of each channel; the construction module is configured to construct a judgment matrix for characterizing a relative importance of a performance parameter of each channel; the checking module is configured to perform a consistency check on the constructed judgment matrix; the normalization module is configured to calculate a weight index matrix according to parameters of the constructed judgment matrix, and perform a normalization process; the calculation module is further configured to calculate a weighted evaluation indicator; the switching module is configured to determine whether to switch communication network according to the calculated weighted evaluation indicator.

The multi-mode communication apparatus for an autonomous transport system of a mining vehicle according to the embodiment can be used to perform the method of the method embodiment as shown in FIG. 1. The implementation principle and technical effects to be achieved in this embodiment are similar to those in that method embodiment, which are therefore omitted here.

It should be noted that the above embodiments are only used to illustrate the technical solutions of the present disclosure, without limiting the scope of protection of the present invention. The present invention has been described in detail with reference to the foregoing embodiments; those skilled in the art should understand that modifications, or equivalents of some technical features, can be made to the technical solutions described herein, without deviation from the spirit and scope of the present invention.

What is claimed is:

1. A multi-mode communication method for an autonomous transport system of a mining vehicle, comprising:
acquiring performance parameters of each channel, where the performance parameters comprise bandwidth, delay, jitter and packet loss rate;
calculating a performance function for each channel according to the acquired performance parameters of each channel;
standardizing the performance function of each channel;
constructing a judgment matrix for characterizing a relative importance of a performance parameter of each channel;
performing a consistency check on the constructed judgment matrix;
calculating a weight index matrix according to parameters of the constructed judgment matrix, and performing a normalization process;
calculating a weighted evaluation indicator;
determining whether to switch communication network according to the calculated weighted evaluation indicator.

2. The method according to claim 1, wherein the calculating a performance function for each channel according to the acquired performance parameters of each channel comprises:
collecting data every 1 s, and determining size of the data, n, according to a preset sampling period T with a calculation formula:
$$n = \frac{1}{T} ;$$
calculating X_{i,k} (k=B,D,J,L) according to a calculation formula:
$${X}_{i , k} ( k = B , D , J , L ) = \frac{1}{n} {\sum }_{i = 1}^{n} {x}_{i , {k}_{j}} ( k = B , D , J , L ) ;$$
where X_{i,k} (k=B,D,J,L) is the average of a series of data of size n, i is a channel identifier, B is bandwidth, D is delay, J is jitter and L is packet loss rate.

3. The method according to claim 2, wherein the standardizing the performance function of each channel comprises:
standardizing the performance function X_{i,k} (k=B,D,J,L) of each channel into Y_{i,k} (k=B,D,J,L), and
Y_{i,k}(k=B)=(k=B)/X_{0,k}(k=B)
Y_{i,k}(k=D,J,L)=1−X_{i,k}(k=D,J,L)/X_{0,k}(k=D,J,L)
where X_{0,k} (k=B,D,J,L) is a standard performance function, determined by technical indicators of a corresponding application, and in solving an autonomous mining vehicle problem, the standard performance function has the set of values below:
X_{0,k}(k=B,D,J,L)=(50 Mbps,150 ms,10 ms,10%).

4. The method according to claim 3, wherein the constructing the judgment matrix comprises:
generating an element table for the judgment matrix A as shown in Table 1 according to a nine-point scale:
TABLE 1
Element table for judgment matrix A

| Importance of parameter u | |
|---|---|
| relative to parameter v | aᵤᵥ |
| Equal importance | 1 |
| Moderate importance | 3 |
| Story importance | 5 |
| Very strong importance | 7 |
| Extreme importance | 9 |

where the judgment matrix A is a 4×4 matrix, and aᵤᵥ in the matrix denotes the importance of a parameter u relative to a parameter v.

5. The method according to claim 4, wherein the performing a consistency check on the constructed judgment matrix comprises:
performing a consistency check on the constructed judgment matrix, and if a consistency check parameter CR<0.1, determining the consistency check is passed.

6. The method according to claim 4, wherein the calculating a weight index matrix according to parameters of the constructed judgment matrix and performing a normalization process comprises:
first, performing initial calculation of the element values of the weight index matrix W according to the calculation formula:
$${W}_{i , k} = \sqrt[4]{{Π}_{i} {a}_{k j}} ( k , j = B , D , J , L ) ;$$
then, performing a normalization process according to the processing formula:
$${w}_{i , k} = \frac{{w}_{i , k}}{Σ {w}_{i , k}} ( k = B , D , J , L ) ,$$
after the normalization process, the final weight index matrix W is obtained.

7. The method according to claim 6, wherein the calculating a weighted evaluation indicator comprises:
calculating a weighted evaluation indicator according to the standardized performance function of each channel and the final weight index matrix obtained after normalization, according to the calculation formula:
Mᵢ=Σw_{i,k}Y_{i,k}(k=B,D,J,L),
where Mᵢ is the weighted evaluation indicator.

8. The method according to claim 7, wherein the determining whether to switch communication network according to the calculated weighted evaluation indicator comprises:
of all communication modes, determining a communication mode with the largest M as the best communication network; and if it is more than 10% larger than the indicator of the current network, switching.

9. The method according to claim 8, wherein the method further comprises selecting other candidate network according to the magnitude of M value.

10. A multi-mode communication apparatus for an autonomous transport system of a mining vehicle, comprising:
an acquisition module, configured to acquire performance parameters of each channel, where the performance parameters comprise bandwidth, delay, jitter and packet loss rate;
a calculation module, configured to calculate a performance function for each channel according to the acquired performance parameters of each channel;
a standardization module, configured to standardize the performance function of each channel;
a construction module, configured to construct a judgment matrix for characterizing a relative importance of a performance parameter of each channel;
a checking module, configured to perform a consistency check on the constructed judgment matrix;
a normalization module, configured to calculate a weight index matrix according to parameters of the constructed judgment matrix, and perform a normalization process;
the calculation module is further configured to calculate a weighted evaluation indicator;
a switching module, configured to determine whether to switch communication network according to the calculated weighted evaluation indicator.
